(19) United States
(12) Patent Application Publication
(10) Pub. No.: US 2022/0398514 A1
(43) Pub. Date: Dec. 15, 2022

(54) METHOD FOR ANALYZING FLOW REGIME ALTERATIONS FROM RESERVOIR INFLOW TO RESERVOIR OUTFLOW

(71) Applicant: SUN YAT-SEN UNIVERSITY, Guangdong (CN)

(72) Inventors: Tongtiegang ZHAO, Guangdong (CN); Zexin CHEN, Guangdong (CN)

(73) Assignee: SUN YAT-SEN UNIVERSITY, Guangdong (CN)

(21) Appl. No.: 17/892,147

(22) Filed: Aug. 22, 2022

Related U.S. Application Data
(63) Continuation of application No. PCT/CN2021/087674, filed on Apr. 16, 2021.

(51) Int. Cl. G06Q 10/06; G01R 23/10

(52) U.S. Cl. CPC G06Q 10/0639; G01R 23/10; G01R 29/0273

(57) ABSTRACT

The present invention provides a method for analyzing flow regime alterations from reservoir inflow to reservoir outflow, including: acquiring a reservoir inflow data series and a reservoir outflow data series, and determining a local water year of reservoir inflow and reservoir outflow; calculating low and high pulses thresholds of indicators of hydrologic alteration (IHA) for reservoir inflow, and environmental flow thresholds of environmental flow component (EFC) for the reservoir inflow; applying thresholds required for low pulse and high pulse of IHA and the environmental flow thresholds of EFC to reservoir outflow, and respectively calculating IHA parameters and EFC parameters of the inflow and the outflow; and using the range of variability approach (RVA) based on IHA and EFC to analyze the flow regime alterations from the reservoir inflow to the reservoir outflow according to the IHA parameters and the EFC parameters of the reservoir inflow and the reservoir outflow.

### CROSS-REFERENCE TO RELATED APPLICATION

This application is a continuation of international PCT application serial no. PCT/CN2021/087674, filed on Apr. 16, 2021. The entirety of the above—mentioned patent application is hereby incorporated by reference herein and made a part of this specification.

### TECHNICAL FIELD

The present invention relates to the technical field of flow regime analysis, and more particularly to a method for analyzing flow regime alterations from reservoir inflow to reservoir outflow.

### BACKGROUND

The natural flow regime plays an important role in maintaining native biodiversity and ecological integrity in riverine ecosystems. The reservoir operation considerably changes the downstream flow conditions, such that an original hydrologic condition is changed. The alterations in flow regime prompt a range of ecological responses that threaten the biodiversity of riverine and riparian ecosystems. Indicators of hydrologic alteration (IHA) which can comprehensively indicate river flow regime include magnitude, frequency, duration, timing, and rate of change.

At present, the research on flow regime alterations of a river mainly focuses on comparing the IHA parameters before and after a particular human activity and then analyzing the flow regime alterations. For example, a publication No. CN107563642A (publication date: 2018-01-09) provides a method for evaluating flow regime of a river with a hydropower station based on projection pursuit. In the publication, a projection pursuit clustering model is used to calculate an overall hydrologic change degree of the river according to the change degree of each single indicator, and the projection pursuit clustering model and an RVA method are coupled and applied to the evaluation of flow regime alteration degree of the river with a hydropower station. The method calculates the overall change degree of the flow regime of the river according to abrupt change points of a daily streamflow series. However, the method is difficult to effectively analyze and evaluate the flow regime alterations from reservoir inflow to outflow due to the inflow and outflow are two concurrent time series.

### SUMMARY

In order to solve the above technical problem, the technical solution of the present invention is as follows:

A method for analyzing flow regime alterations from reservoir inflow to reservoir outflow, including the following steps:

Acquiring a reservoir inflow data series and a reservoir outflow data series, and determining a local water year of reservoir inflow and reservoir outflow;

Calculating division parameters required for low and high pulses of IHA (indicators of hydrologic alteration) for reservoir inflow, and environmental flow division parameters of EFC (environmental flow component) for the reservoir inflow; applying the division parameters required for low pulse and high pulse of IHA and the environmental flow division parameters of EFC to reservoir outflow, and respectively calculating the IHA parameters and the EFC parameters of the reservoir inflow and the reservoir outflow; and

Using the range of variability approach (RVA) based on the IHA and EFC to analyze the flow regime alterations from the reservoir inflow to the reservoir outflow according to the IHA parameters and the EFC parameters of the reservoir inflow and the reservoir outflow.

Specifically, in the above method for analyzing flow regime alterations from reservoir inflow to reservoir outflow, the reservoir inflow data series is a reservoir inflow time series; the division parameters required for low and high pulses of IHA for the reservoir inflow are low and high pulses thresholds of IHA for reservoir inflow; the environmental flow division parameters of EFC for the reservoir inflow are environmental flow thresholds of EFC for the reservoir inflow.

As a preferred solution, the IHA parameters includes monthly mean flows, annual 1-day, 3-day, 7-day, 30-day and 90-day minimum flows, annual 1-day, 3-day, 7-day, 30-day and 90-day maximum flows, number of zero-flow days, base flow index, date of annual maximum flow, date of annual minimum flow, high pulse count, low pulse count, high pulse duration, low pulse duration, rise rate, fall rate and number of reversals.

As a preferred solution, the step of determining the local water year includes: selecting a month with a lowest long-term monthly mean inflow from 12 months as a start month of the water year.

As a preferred solution, the EFC parameters includes low flow in each month, magnitude, frequency, duration and timing of extreme low flows, magnitude, frequency, duration, timing, and rise and fall rates of high flow pulses, magnitude, frequency, duration, timing, and rise and fall rates of small floods, and magnitude, frequency, duration, timing, and rise and fall rates of large floods.

As a preferred solution, the step of calculating the division parameters required for low pulse and high pulse of IHA for the reservoir inflow includes: sequencing the reservoir inflow data series in an ascending order, and taking a 25-th percentile in the reservoir inflow data series as a low pulse division parameter of IHA, and taking a 75-th percentile in the reservoir inflow data series as a high pulse division parameter of IHA. Specifically, in this solution, the low pulse division parameter of IHA is a low pulse threshold of IHA; the high pulse division parameter of IHA is a high pulse threshold of IHA.

As a preferred solution, the high pulse division parameter of IHA is taken as an initial EFC flow division parameter to initially divide the reservoir inflow; the flow higher than the initial EFC flow division parameter in the reservoir inflow are taken as initial high flows; and the flow lower than the initial EFC flow division parameter in the reservoir inflow are taken as initial low flows. Specifically, in this solution, the initial EFC flow division parameter is an initial EFC flow threshold.

As a preferred solution, the method further includes the following steps: dividing the initial high flows into a plurality of initial high flow series, and performing determination on the plurality of initial high flow series one by one:

If a maximum flow in a current initial high flow series is higher than a preset first threshold, then dividing the initial high flow series into a small flood;

If the maximum flow in the current initial high flow series is higher than a preset second threshold, then dividing the initial high flow series into a large flood; and

If the maximum flow in the current initial high flow series is lower than the preset first threshold, then dividing the initial high flow series into a high flow pulse.

As a preferred solution, the first threshold and the second threshold are respectively obtained by using a Pearson type-III distribution to perform fitting.

As a preferred solution, the method further includes the following steps: taking a 10-th percentile in the sequenced inflow series as an extreme low flow division parameter, dividing the flow lower than the extreme low flow division parameter in the initial low flows as extreme low flows, and dividing the flow higher than the extreme low flow division parameter in the initial low flows as low flows. Specifically, in this solution, the extreme low flow division parameter is an extreme low flow threshold.

As a preferred solution, the method further includes the following step: visualizing the IHA parameters, the EFC parameters, and analysis results of the flow regime alterations from the reservoir inflow to the reservoir outflow.

### BRIEF DESCRIPTION OF DRAWINGS

FIG. 1 is a flow chart of a method for analyzing flow regime alterations from inflow to reservoir outflow according to the present invention;

FIG. 2 is a flow chart of the method for analyzing flow regime alterations from inflow to reservoir outflow according to one embodiment;

FIG. 3 is an EFC comparison diagram of the inflow and the outflow according to one embodiment;

FIG. 4 is a comparison diagram of monthly mean flow of the reservoir inflow and the reservoir outflow in May according to one embodiment;

FIG. 5 is a comparison diagram of monthly low flows of the reservoir inflow and the reservoir outflow in April according to one embodiment;

FIG. 6 is a comparison diagram of the reservoir inflow and the reservoir outflow according to one embodiment;

FIG. 7 is a comparison diagram of annual minimum flows of the reservoir inflow and the reservoir outflow according to one embodiment; and

FIG. 8 is a comparison diagram of frequencies and durations of annual high pulses of the reservoir inflow and the reservoir outflow according to one embodiment.

### DETAILED DESCRIPTION OF EMBODIMENTS

In order to overcome the defect in the prior art that a study on the IHA focuses on one time series while reservoir inflow and reservoir outflow are two concurrent time series, the present invention provides a method for analyzing flow regime alterations from reservoir inflow to reservoir outflow.

The drawings are used for illustrative purpose only, but should not be considered as a limitation to the present patent.

For a person skilled in the art, that certain commonly known structures in the figures and the descriptions thereof is understandable.

The technical solution of the present invention will be further described below with reference to the accompanying drawings and embodiments.

### Embodiment

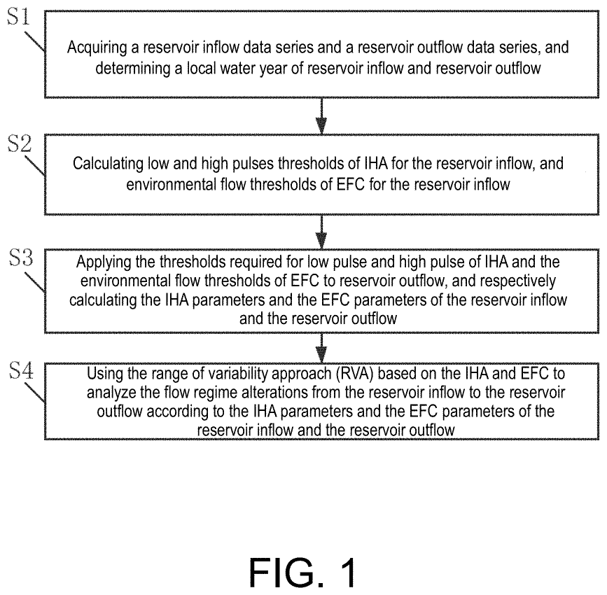

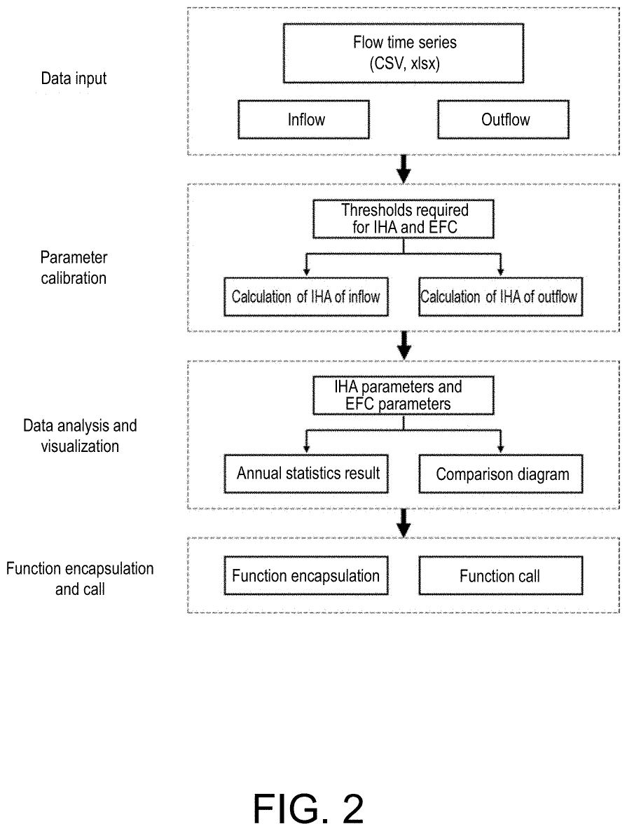

The present embodiment provides a method for analyzing flow regime alterations from reservoir inflow to reservoir outflow. FIGS. 1-2 are flow charts of the method for analyzing flow regime alterations from reservoir inflow to reservoir outflow according to the present embodiment.

The method for analyzing flow regime alterations from reservoir inflow to reservoir outflow provided by the present embodiment includes the following steps:

Step 1, acquiring a reservoir inflow data series and a reservoir outflow data series, and determining a local water year of reservoir inflow and reservoir outflow;

Step 2, calculating low and high pulses threshold of IHA for the reservoir inflow, and environmental flow thresholds of EFC for the reservoir inflow;

Step 3, applying the thresholds required for low pulse and high pulse of IHA and the environmental flow thresholds of EFC to reservoir outflow, and respectively calculating the IHA parameters and the EFC parameters of the reservoir inflow and the reservoir outflow; and

Step 4, using the range of variability approach (RVA) based on the IHA and EFC to analyze the flow regime alterations from the reservoir inflow to the reservoir outflow according to the IHA parameters and the EFC parameters of the reservoir inflow and the reservoir outflow.

In the present embodiment, there are totally 33 IHA (indicators of hydrologic alteration) parameters, including five components: magnitude, frequency, timing, duration, and rate of change. The parameters specifically include monthly mean flows, annual 1-day, 3-day, 7-day, 30-day and 90-day minimum flows, annual 1-day, 3-day, 7-day, 30-day and 90-day maximum flows, number of zero-flow days, base flow index, date of annual maximum flow, date of annual minimum flow, high pulse count, low pulse count, high pulse duration, low pulse duration, rise rate, fall rate and number of reversals. The specific details are as shown in table 1.

TABLE 1
IHA parameters

| | | Number |
|---|---|---|
| IHA parameters | Hydrologic | of the |
| group | parameters | parameters |
| Magnitude of monthly | Monthly mean flows | 12 |
| water conditions | | |
| Magnitude and duration | Annual 1-day, 3-day, 7-day, | 12 |
| of annual extreme | 30-day, 90-day maximum | |
| water conditions | and minimum flows; | |
| | Number of zero-flow days; | |
| | Base flow index | |
| Timing of annual | date of annual maximum | 2 |
| extreme water | and minimum flows | |
| conditions | | |
| Frequency and duration | High pulse count; Low pulse | 4 |
| of high and low pulses | count; High pulse duration; | |
| | Low pulse duration | |
| Rate and frequency of | Rise rate; Fall rate; | 3 |
| water condition changes | Number of reversals | |

In the present embodiment, there are totally 34 EFC (environmental flow component) parameters, including five components: magnitude, frequency, timing, duration, and rate of change. The parameters specifically include low flow in each month, magnitude, frequency, duration and timing of extreme low flows, magnitude, frequency, duration, timing, and rise and fall rates of high flow pulses, magnitude, frequency, duration, timing, and rise and fall rates of small floods, and magnitude, frequency, duration, timing, and rise and fall rates of large floods. The specific details are as shown in table 2.

TABLE 2
EFC parameters

| | | Number |
|---|---|---|
| EFC | Hydrologic | of the |
| type | parameters | parameters |
| Low flow | Low flow in each month | 12 |
| Extreme low | Magnitude, frequency, duration and timing of | 4 |
| flows | extreme low flows | |
| High flow | Magnitude, frequency, duration, timing, and | 6 |
| pulses | rise and fall rates of high flow pulses | |
| Small floods | Magnitude, frequency, duration, timing, and | 6 |
| | rise and fall rates of small floods | |
| Large floods | Magnitude, frequency, duration, timing, and | 6 |
| | rise and fall rates of large floods | |

In the present embodiment, a month with a lowest long-term monthly mean reservoir inflow is selected from 12 months as a start month of the water year.

Further, the reservoir inflow data series is divided into low pulse and high pulse according to the thresholds of IHA, wherein the reservoir data inflow series are sequenced in an ascending order; a 25-th percentile in the reservoir inflow data series is taken as the low pulse threshold of IHA; and a 75-th percentile in the reservoir inflow data series is taken as the high pulse threshold of IHA. The expression formula is as follows:

HighPulse≥Q₇₅

LowPulse≤Q₂₅

Wherein HighPulse denotes high pulse; LowPulse denotes low pulse; Q₇₅ denotes the 75-th percentile of the sequenced reservoir inflow data series; and Q₂₅ denotes the 25-th percentile of the sequenced reservoir inflow data series.

The 75-th percentile of the sequenced reservoir inflow data series Q₇₅ is taken as an initial high flow and initial low flow thresholds in the EFC. Specifically, the flow higher than Q₇₅ in the reservoir inflow data series is taken as initial high flows, and the flow lower than Q₇₅ in the reservoir inflow data series is taken as initial low flows. The expression formula is as follows:

InitialHigh>Q₇₅

InitialLow<Q₇₅

Wherein InitialHigh denotes the initial high flows, and InitialLow denotes the initial low flows.

Further, the divided initial high flows are further divided into high flow pulse, small flood, and large flood in the EFC. Specifically, the plurality of initial high flow series are determined one by one:

If a maximum flow in a current initial high flow series is higher than a preset first threshold, then dividing the initial high flow series into a small flood;

If the maximum flow in the current initial high flow series is higher than a preset second threshold, then dividing the initial high flow series into a large flood; and

If the maximum flow in the current initial high flow series is lower than the preset first threshold, then dividing the initial high flow series into a high flow pulse.

In the present embodiment, the first threshold is a flow with the return period of 2 years; the second threshold is a flow with the return period of 10 years; the first threshold and the second threshold are respectively obtained by using a Pearson type-III distribution to perform fitting; the flow at a corresponding frequency is calculated according to the fitting result, wherein the expression formula of a density function f(x) of the Pearson type-III distribution is as follows:

$$f ( x ) = \frac{{β}^{α}}{Γ ( α )} {( x - {a}_{0} )}^{α - 1} {e}^{- β ( x - {a}_{0} )} , x > {a}_{0}$$

Wherein Γ(α) is a gamma function of α, and α, β, and α₀ are respectively the shape, size, and position unknown parameters of the Pearson type-III distribution.

Further, the initial low flow is further divided to the extreme low flows and low flows in the EFC, wherein a 10-th percentile in the sequenced inflow series is taken as an extreme low flow threshold; the flow lower than the extreme low flow threshold in the initial low flows is taken as extreme low flows; and the flow higher than the extreme low flow threshold in the initial low flows is taken as low flows. The expression formula is as follows:

ExtremeLowFlow<Q₁₀

Wherein ExtremeLowFlow denotes extreme low flows; Q₁₀ denotes the 10-th percentile of the sequenced reservoir inflow data series.

The reservoir inflow is divided via the above steps; the IHA parameters and the EFC parameters of the inflow are obtained by calculation; the above thresholds are applied to the division of the reservoir outflow; the IHA parameters and the EFC parameters of the reservoir outflow are obtained by calculation; and then the regime of reservoir inflow and the regime of reservoir outflow are further analyzed as needed by using the range of variability approach (RVA) based on the IHA, so as to obtain the analysis results of the flow regime alterations from the reservoir inflow to the reservoir outflow.

Further, the above calculation result is analyzed and visualized. That is, to visualize the IHA parameters, the EFC parameters, and analysis results, so as to intuitively analyze the flow regime alterations.

The method for analyzing flow regime alterations from reservoir inflow to reservoir outflow provided in the present embodiment can compare the IHA parameters of the reservoir inflow and the reservoir outflow, uses the relevant method to analyze the impact of reservoir operation on the flow regime, and provides reference information for the ecological protection of the riverine ecosystems.

In a specific implementation process, a reservoir inflow and reservoir outflow data series of Xinfengjiang reservoir in the East River basin is analyzed with the flow regime alteration analysis method provided in the present embodiment. The specific steps are as follows:

First, preparing reservoir inflow and reservoir outflow series data required for analyzing the flow regime alteration from reservoir inflow to reservoir outflow of the Xinfengjiang reservoir in the East River basin, as shown in table 3. In the table, the first column is a date index corresponding to observed values; the parameter inflow in the second column is reservoir inflow; the parameter outflow in the third column is reservoir outflow. The reservoir inflow and reservoir outflow data series is the observed data from Jan. 1, 2001 to Dec. 31, 2019.

TABLE 3
Reservoir inflow and reservoir outflow series of
Xinfengjiang reservoir in the East River basin

| | inflow | outflow |
|---|---|---|
| 2001 Jan. 1 | 7.78 | 7.89 |
| 2001 Jan. 2 | 48.9 | 156 |
| 2001 Jan. 3 | 45.3 | 218 |
| 2001 Jan. 4 | 34.6 | 99.6 |
| 2001 Jan. 5 | 45.3 | 201 |
| 2001 Jan. 6 | 35 | 192 |
| 2001 Jan. 7 | 20.7 | 40.2 |
| 2001 Jan. 8 | 41.8 | 149 |
| 2001 Jan. 9 | 24.4 | 100 |
| 2001 Jan. 10 | 24.8 | 213 |
| 2001 Jan. 11 | 39.8 | 197 |
| 2001 Jan. 12 | 40.4 | 131 |
| 2001 Jan. 13 | 35.2 | 28.9 |
| 2001 Jan. 14 | 29.1 | 94.1 |
| 2001 Jan. 15 | 48.5 | 120 |

A read_csv function in a Pandas package of a third party library Python is used to read data in a data file; furthermore, a to_datetime function therein is used to create a Pandas identifiable datetime object according to the data index.

A quantile function in a Numpy package of the third party library Python is used to calculate thresholds required for the IHA and the EFC. The Pearson type-III distribution is fitted by using a curve_fit function of scipy.optimize. After the thresholds are determined, the 33 IHA parameters and the 34 EFC parameters are sequentially calculated:

1) The water year of is determined according to the definition of the local water year, and the water year is taken as the calculation time;

2) The thresholds required for the division of the environmental flow components of the inflow series are calculated, and are used in the inflow series and an outflow series;

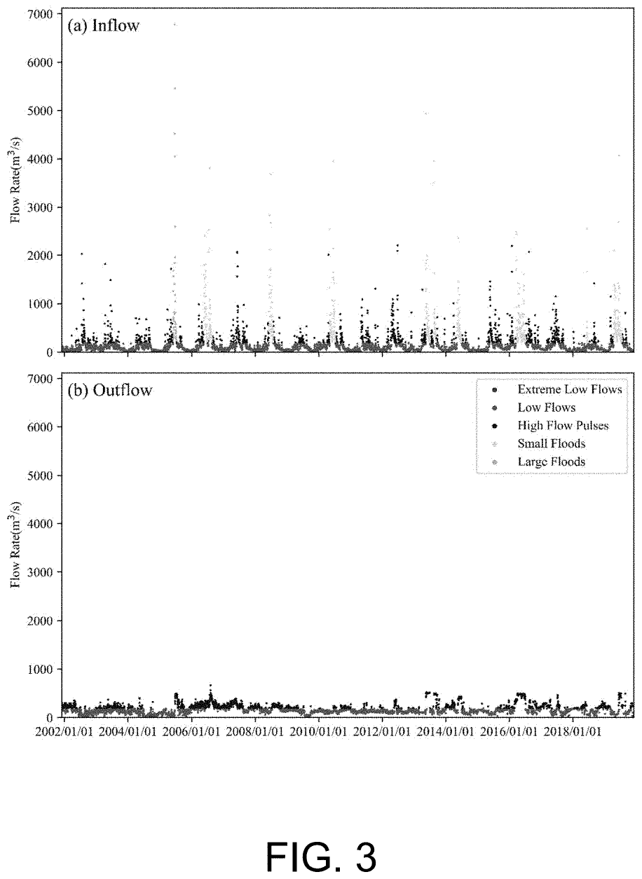

3) The components of the EFC in reservoir inflow and reservoir outflow series are divided according the calculated thresholds; a pyplot.scatter function in Matplotlib is used to draw an EFC comparison diagram of the reservoir inflow and the reservoir outflow, as shown in FIG. 3;

4) The 33 IHA parameters and the 34 EFC parameters of the reservoir inflow and the reservoir outflow are respectively calculated; and the parameters calculation results of the reservoir inflow and the reservoir outflow are respectively stored by using pandas.DataFrame.

Numerical results are obtained according to the above calculation; the Matplotlib of the third party library Python is used to visualize the numerical results; the numerical results obtained according to the above calculation and the picture result obtained in the present step are stored with different storage methods. The specific methods are as follows:

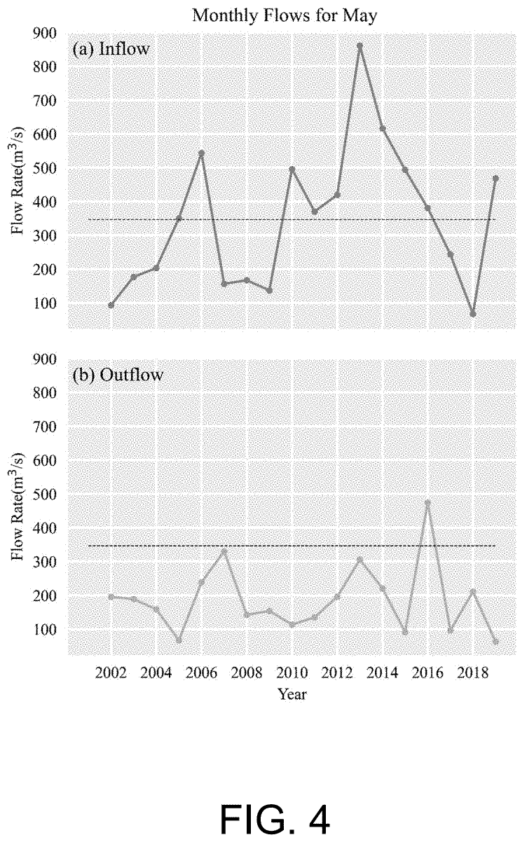

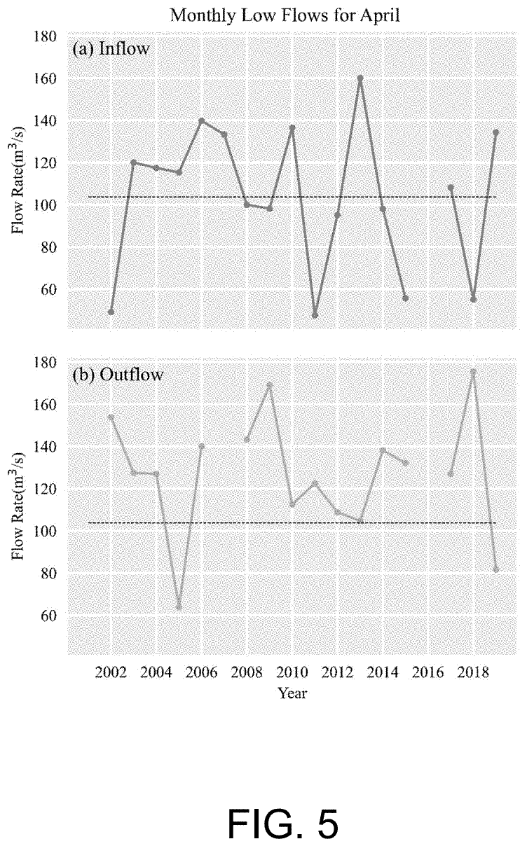

1) A pyplot.plot function is used to visualize the mean flow in May in the IHA parameters of the reservoir inflow and the reservoir outflow, as shown in FIG. 4; and the function is also used to visualize the low flow in April in the EFC parameters, as shown in FIG. 5;

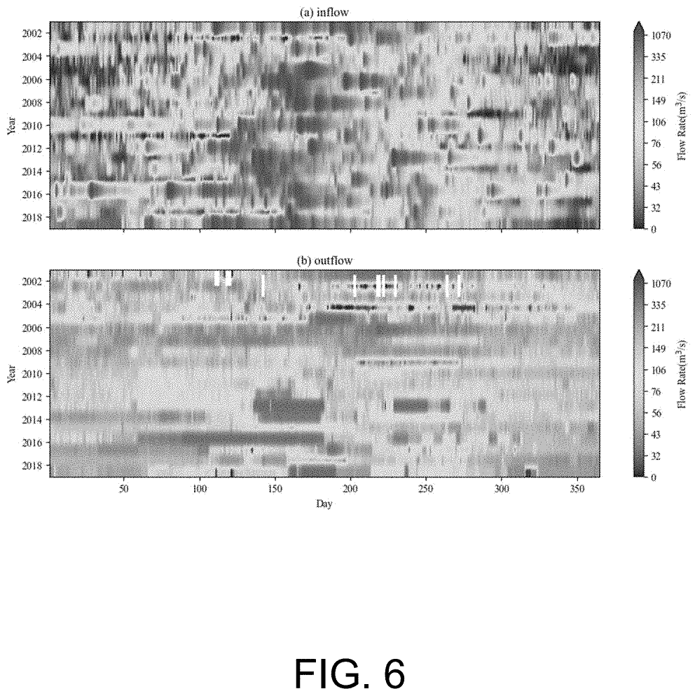

2) A pyplot.imshow function is used to draw a comparison diagram of the reservoir inflow and the reservoir outflow, as shown in FIG. 6;

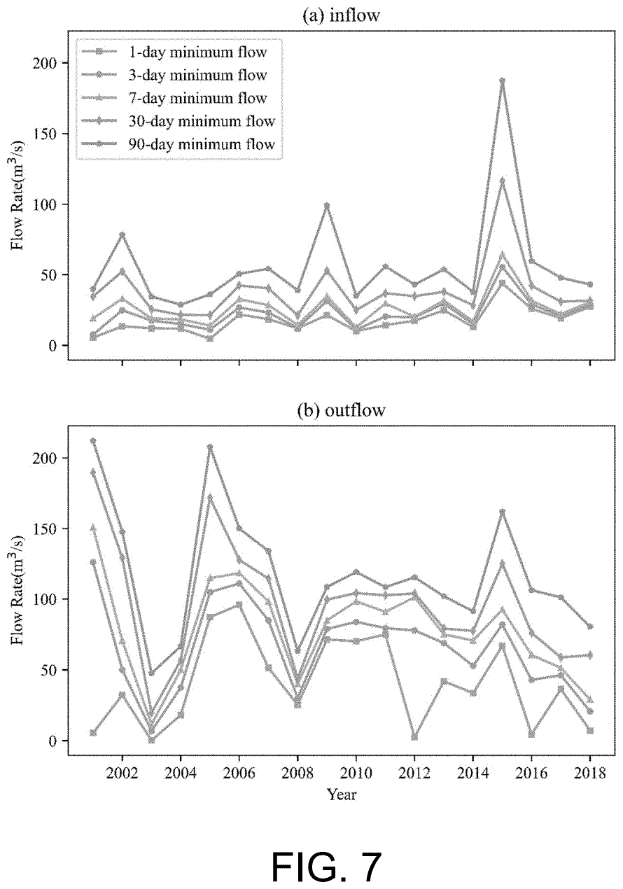

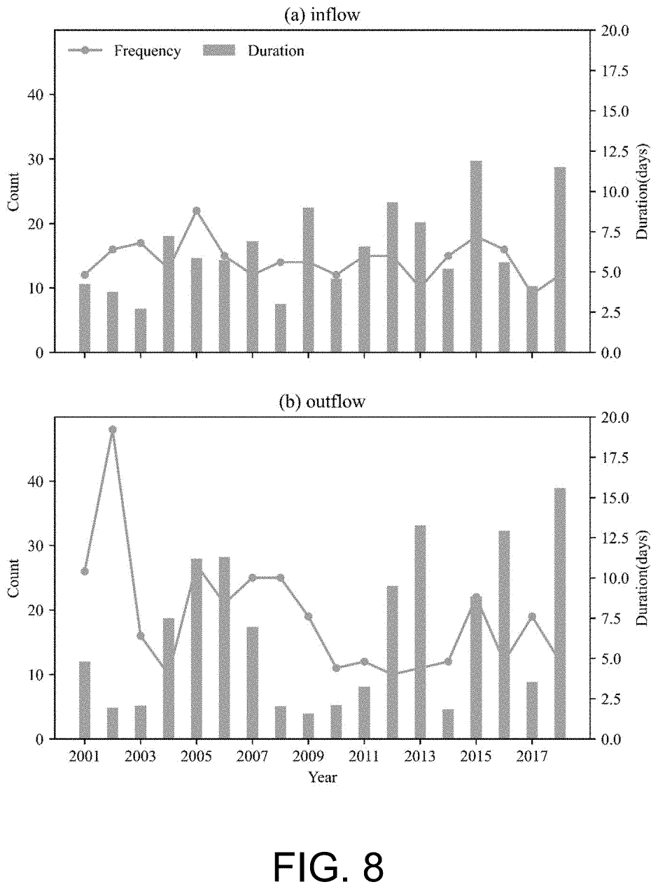

3) The pyplot.plot function is used to draw a comparison diagram of annual minimum flows of the reservoir inflow and the reservoir outflow, as shown in FIG. 7; the pyplot.plot function and a pyplot.bar function are used draw a comparison diagram of frequencies and durations of high pulses of the reservoir inflow and the reservoir outflow, as shown in FIG. 8;

4) Storage of the numerical results: the object pandas.DataFrame is stored at a specified position in a CSV format by means of a to_csv( ) function; and

5) Storage of picture results: the picture results are stored at specified positions by means of a savefig function in Matplotlib.

Further, the categories are defined by using class sentences; the components in the EFC and functions for calculating the IHA and EFC parameters are defined by using def( ) in the categories; the mathematical process and drawing process related to the functions are realized by means of programming, and are encapsulated to be class functions, and are stored as a .py file; the flow regime alterations from the inflow to the outflow can be analyzed only by calling the encapsulated class functions.

The method for analyzing flow regime alterations from reservoir inflow to reservoir outflow provided by the present embodiment is implemented on the platform Python; all the calculation and analysis steps are encapsulated to be class functions; during use, the IHA parameters and the EFC parameters can be automatically calculated only by inputting the inflow and outflow series. Furthermore, the class functions have a drawing function, and can conveniently obtain comparison diagrams of the parameters related to the inflow and the outflow for practical use and analysis.

Compared with the prior art, the beneficial effects of the technical solution of the present invention are: IHA and EFC focused on one time series by examining the IHA (EFC) parameters before and after a certain human activity while inflow and outflow are two concurrent time series, thereby preventing the analysis of the impact of reservoir operation on flow regime alterations. The present invention uses the range of variability approach (RVA) based on the IHA to analyze the impact of reservoir operation on the flow regime, and provides reference information for the ecological environmental protection of the river.

The words for describing position relationships in the drawings are used for illustrative purpose only, but should not be considered as a limitation to the present patent.

It is obvious that the above embodiments of the present invention are only examples for clearly illustrating the present invention, but not limitations to the embodiments of the present invention. A person skilled in the art may make various modifications or variations in other forms on the basis of the above description. It is unnecessary and impossible to exhaust all the embodiments herein. Any modifications, equivalent substitutions, improvements and the like made within the spirit and principles of the present invention are all intended to be concluded in the scope of protection of the claims of the present invention.

What is claimed is:

1. A method for analyzing flow regime alterations from reservoir inflow to reservoir outflow, comprising:
acquiring a reservoir inflow data series and a reservoir outflow data series, and determining a local water year of the reservoir inflow and the reservoir outflow;
calculating division parameters required for low and high pulses of indicators of hydrologic alteration (IHA) for the reservoir inflow, and environmental flow division parameters of environmental flow component (EFC) for the reservoir inflow;
applying the division parameters required for low pulse and high pulse of IHA and the environmental flow division parameters of EFC to reservoir outflow, and respectively calculating IHA parameters and EFC parameters of the reservoir inflow and the reservoir outflow; and
using a range of variability approach based on the IHA to analyze the flow regime alterations from the reservoir inflow to the reservoir outflow according to the IHA parameters and the EFC parameters of the reservoir inflow and the reservoir outflow.

2. The method for analyzing flow regime alterations according to claim 1, wherein the IHA parameters comprise monthly mean flows, annual 1-day, 3-day, 7-day, 30-day and 90-day minimum flows, annual 1-day, 3-day, 7-day, 30-day and 90-day maximum flows, number of zero-flow days, base flow index, date of annual maximum flow, date of annual minimum flow, high pulse count, low pulse count, high pulse duration, low pulse duration, rise rate, fall rate and number of reversals.

3. The method for analyzing flow regime alterations according to claim 2, wherein the determining a local water year comprises:
selecting a month with a lowest long-term monthly mean inflow from 12 months as a start month of the water year.

4. The method for analyzing flow regime alterations according to claim 2, wherein the EFC parameters comprise low flow in each month, magnitude, frequency, duration and timing of extreme low flows, magnitude, frequency, duration, timing, and rise and fall rates of high flow pulses, magnitude, frequency, duration, timing, and rise and fall rates of small floods, and magnitude, frequency, duration, timing, and rise and fall rates of large floods.

5. The method for analyzing flow regime alterations according to claim 4, wherein the step of calculating the division parameters required for low pulse and high pulse of IHA for the reservoir inflow comprises:
sequencing the reservoir inflow data series in an ascending order, and taking a 25-th percentile in the reservoir inflow data series as a low pulse division parameter of IHA, and taking a 75-th percentile in the reservoir inflow data series as a high pulse division parameter of IHA.

6. The method for analyzing flow regime alterations according to claim 5, wherein the high pulse division parameter of IHA is taken as an initial EFC flow division parameter to initially divide the reservoir inflow; the flow higher than the initial EFC flow division parameter in the reservoir inflow are taken as initial high flows; and the flow lower than the initial EFC flow division parameter in the reservoir inflow are taken as initial low flows.

7. The method for analyzing flow regime alterations according to claim 6, wherein the method further comprises:
dividing the initial high flows into a plurality of initial high flow series, and performing determination on the plurality of initial high flow series one by one:
if a maximum flow in a current initial high flow series is higher than a preset first threshold, then dividing the initial high flow series into a small flood;
if the maximum flow in the current initial high flow series is higher than a preset second threshold, then dividing the initial high flow series into a large flood; and
if the maximum flow in the current initial high flow series is lower than the preset first threshold, then dividing the initial high flow series into a high flow pulse.

8. The method for analyzing flow regime alterations according to claim 7, wherein the first threshold and the second threshold are respectively obtained by using a Pearson type-III distribution to perform fitting.

9. The method for analyzing flow regime alterations according to claim 6, wherein the method further comprises:
taking a 10-th percentile in the sequenced inflow data series as an extreme low flow division parameter, dividing the flow lower than the extreme low flow division parameter in the initial low flows as extreme low flows, and dividing the flow higher than the extreme low flow division parameter in the initial low flows as low flows.

10. The method for analyzing flow regime alterations according to claim 1, wherein the method further comprises:
visualizing the IHA parameters, the EFC parameters, and analysis results of the flow regime alterations from the reservoir inflow to the reservoir outflow.

11. The method for analyzing flow regime alterations according to claim 2, wherein the method further comprises:
visualizing the IHA parameters, the EFC parameters, and analysis results of the flow regime alterations from the reservoir inflow to the reservoir outflow.

12. The method for analyzing flow regime alterations according to claim 3, wherein the method further comprises:
visualizing the IHA parameters, the EFC parameters, and analysis results of the flow regime alterations from the reservoir inflow to the reservoir outflow.

13. The method for analyzing flow regime alterations according to claim 4, wherein the method further comprises:
visualizing the IHA parameters, the EFC parameters, and analysis results of the flow regime alterations from the reservoir inflow to the reservoir outflow.

14. The method for analyzing flow regime alterations according to claim 5, wherein the method further comprises:
visualizing the IHA parameters, the EFC parameters, and analysis results of the flow regime alterations from the reservoir inflow to the reservoir outflow.

15. The method for analyzing flow regime alterations according to claim 6, wherein the method further comprises:
visualizing the IHA parameters, the EFC parameters, and analysis results of the flow regime alterations from the reservoir inflow to the reservoir outflow.

16. The method for analyzing flow regime alterations according to claim 7, wherein the method further comprises:
visualizing the IHA parameters, the EFC parameters, and analysis results of the flow regime alterations from the reservoir inflow to the reservoir outflow.

17. The method for analyzing flow regime alterations according to claim 8, wherein the method further comprises:
visualizing the IHA parameters, the EFC parameters, and analysis results of the flow regime alterations from the reservoir inflow to the reservoir outflow.

18. The method for analyzing flow regime alterations according to claim 9, wherein the method further comprises:
visualizing the IHA parameters, the EFC parameters, and analysis results of the flow regime alterations from the reservoir inflow to the reservoir outflow.
